(19) United States
(12) Patent Application Publication
(10) Pub. No.: US 2006/0103682 A1
(43) Pub. Date: May 18, 2006

(54) Liquid crystal panel drive device

(76) Inventors: Takashi Kunimori, Tottori-Shi (JP); Nobutoshi Kariya, Tottori-Shi (JP); Satoru Hiraga, Tottori-Shi (JP); Yutaka Nojiri, Tottori-Shi (JP); Atsushi Kanehira, Tottori-Shi (JP)

Correspondence Address: MCDERMOTT WILL & EMERY LLP, 600 13TH STREET, N.W., WASHINGTON, DC, 20005-3096, US

(21) Appl. No.: 10/531,083

(22) PCT Filed: Oct. 6, 2003
(86) PCT No.: PCT/JP03/12804

§ 371 Date: Sep. 23, 2005

(30) Foreign Application Priority Data
Oct. 10, 2002 (JP) 2002297140

(51) Int. Cl. G09G 5/10

(52) U.S. Cl. 345/690

(57) ABSTRACT

A liquid crystal panel drive device performs overdrive by using a frame memory (1) and a lookup table (2). The device is characterized by that there are provided a plurality of types of lookup table (2) to be used according to temperature and the lookup tables (2) are selectively switched from one to another according to the information indicating the ambient temperature. The device is configured so as to have a hysteretic characteristic when the tables are switched from one to another according to the temperature information.

### TECHNICAL FIELD

The present invention relates to a method and an apparatus for driving a liquid crystal panel at high speed by overdriving it.

### BACKGROUND ART

There have conventionally been proposed techniques for operating a liquid crystal panel at higher speed by overdriving it, i.e., by applying a higher than normal voltage thereto, as shown in FIG. 16 (see, for example, Japanese Patent Application Laid-Open No. 2001-265298). This helps achieve smooth display of moving pictures. Among such techniques is one relying on a configuration as shown in FIG. 17. In this configuration, there are provided a frame memory 101 and a lookup table (LUT) 102, and overdrive data is fed from this lookup table 102 to a liquid crystal (LCD) module 104. Here, the overdrive data is set based on the relationship between previous-frame data (start data) and input data (target data). This configuration permits comparatively accurate overdriving.

The response of liquid crystal, however, depends greatly on temperature. Thus, the problem here is that, with a single lookup table prepared, it is not possible to cope with variations in the optimum amount of overdrive resulting from variations in the ambient temperature.

In a case where a plurality of lookup tables are prepared for different temperatures, it is preferable, from the perspective of high-speed response, that the lookup tables be stored in a storage device that can operate at high speed. Storage devices that can operate at high speed, however, are expensive. Thus, the problem here is that using a plurality of such storage devices leads to high cost.

In view of the conventionally encountered problems discussed above, it is an object of the present invention to provide a driving method and a driving apparatus that permit optimum overdriving even in the face of variations in the ambient temperature. It is another object of the present invention to provide a driving method and a driving apparatus that require a smaller number of expensive storage devices.

### DISCLOSURE OF THE INVENTION

To achieve the above objects, according to the present invention, in a liquid crystal panel drive device that achieves overdriving by using a frame memory and a lookup table, a plurality of lookup tables are provided so as to correspond to different temperatures, and the lookup tables are switched from one to another so that one of the lookup tables is selectively used according to information indicating an ambient temperature.

Here, the lookup tables are switched from one to another with hysteresis secured in between.

Specifically, a first lookup table corresponding to a first temperature and a second lookup table corresponding to a second temperature immediately above or below the first temperature are used, and the interpolated amount of overdrive corresponding to a temperature between the first and second temperatures is calculated.

Alternatively, a first storage device in which the plurality of lookup tables are stored and a second storage device, having a smaller storage capacity than the first storage device, for storing a lookup table read out from the first storage device are provided, and a predetermined number, corresponding to the ambient temperature, of lookup tables are read out from the first storage device and stored in the second lookup table.

Here, when lookup tables are read out from the first storage device and stored in the second storage device, corrections are made according to temperature information.

In a liquid crystal panel drive device according to the present invention, data for overdriving is generated in the following manner. The lookup table is fed with part of previous-frame data read out from the frame memory and part of input data, and data for overdriving is generated based on another part of the input data which is not fed to the lookup table and output data from the lookup table.

Alternatively, the lookup table is fed with part of previous-frame data read out from the frame memory and part of input data, and output data from the lookup table is so set that part thereof is used as complementary data. Correction data is generated based on another part of the input data which is not fed to the lookup table and the part of the output data from the lookup table which is used as the complementary data, and data for overdriving is generated based on the correction data and non-complementary part data from the lookup table.

### BRIEF DESCRIPTION OF DRAWINGS

FIG. 1 is a block diagram showing an outline of an example of the overdriving achieved by a liquid crystal panel drive device according to the invention.

FIG. 2 is a characteristic diagram showing the correlation between overdrive gradations and target gradations.

FIG. 3 is a block diagram showing an outline of another example of the overdriving achieved by a liquid crystal panel drive device according to the invention.

FIG. 4 is a diagram illustrating the overdriving achieved in FIG. 3.

FIG. 5 is a characteristic diagram showing the correlation between overdrive gradations and target gradations.

FIG. 6 is a block diagram of an embodiment of the invention.

FIG. 7 is a diagram illustrating the correspondence between temperatures and lookup tables.

FIG. 8 is a characteristic diagram showing how lookup tables are switched as temperature varies.

FIG. 9 is a diagram illustrating the correspondence between temperatures and lookup tables.

FIG. 10 is a diagram illustrating the correspondence between temperatures and lookup tables.

FIG. 11 is a characteristic diagram showing how lookup tables are switched as temperature varies.

FIG. 12 is a block diagram of another embodiment of the invention.

FIG. 13 is a block diagram of another embodiment of the invention.

FIG. 14 is a flow chart showing the operation of the embodiment shown in FIG. 13.

FIG. 15 is a block diagram of another embodiment of the invention.

FIG. 16 is a diagram illustrating an outline of overdriving.

FIG. 17 is a block diagram showing a conventional liquid crystal panel drive device.

### BEST MODE FOR CARRYING OUT THE INVENTION

Hereinafter, the best mode for carrying out the present invention will be described with reference to the accompanying drawings.

First, a description will be given of the configuration of a liquid crystal panel drive device. According to the present invention, there are provided different lookup tables (LUTs), of which an appropriate one is used that suits temperature. How they are switched will be discussed later. First, a description will be given of the driving method used when which lookup table to use has already been decided.

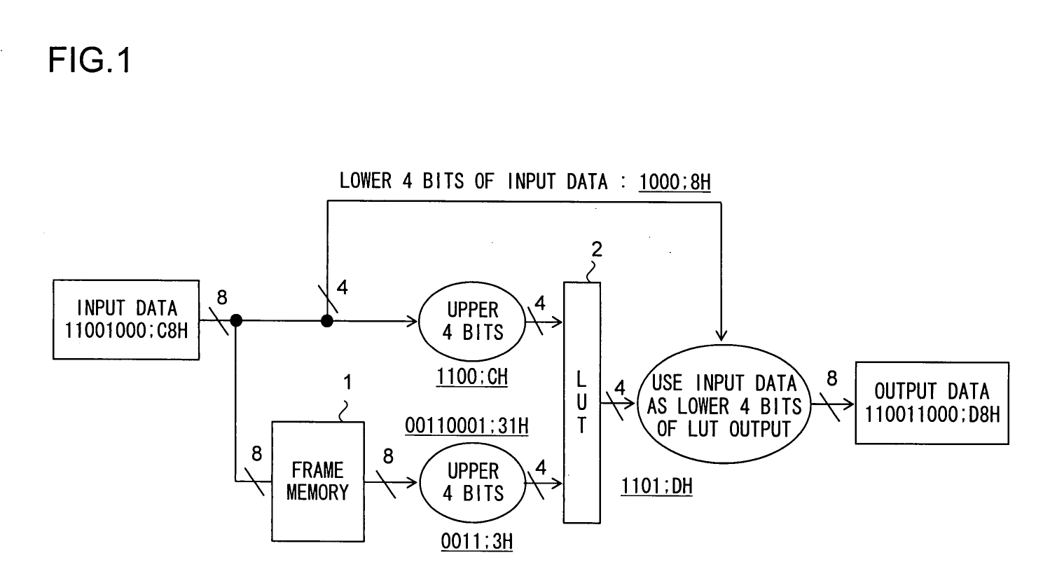

In a liquid crystal panel drive device configured as shown in FIG. 1, input data to be used for gradation display and containing data corresponding to at least one frame is fed to a frame memory 1 and held therein. Here, the input data (target data) is eight-bit data, and is used to achieve gradation display on a display panel.

One frame period later, the input data is fed out of the frame memory 1. That is, when input data is newly fed to the frame memory 1, the data one frame previous to it (hereinafter referred to as previous-frame data) is read out from the frame memory 1. The upper four bits of the previous-frame data and the upper four bits of the input data are fed, as an address, to a lookup table (LUT) 2. Addressed with this eight-bit signal, the lookup table 2 has only to have four-bit data at each address. When accessed at the address consisting of the upper four bits of the previous-frame data and the upper four bits of the input data, the lookup table 2 outputs four bits. These four bits are, as upper four bits, combined with, as lower four bits, the lower four bits of the input data, and in this way eight-bit output data is eventually generated that will be used as overdrive data.

In the example shown in FIG. 1, the upper four bits “1100” of input data “11001000” (C8H) and the upper four bits “0011” of previous-frame data “00110001” (31H) are fed, as an address, to the lookup table 2, which then outputs “1101”. To this, the lower four bits “1000” of the input data is appended, so that eight-bit data “11011000” (D8H) is eventually fed out.

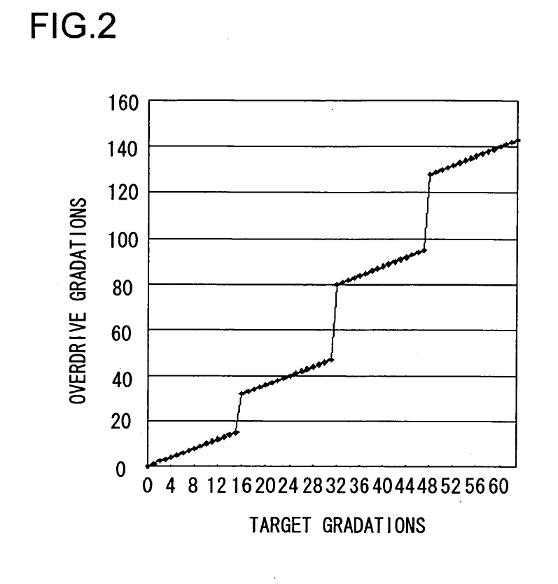

FIG. 2 shows the overdrive gradations obtained by this method (when previous-frame data has zero gradations). As will be understood from FIG. 2, the method helps minimize the number of “cliffs” (discontinuities) in output data. When output data is generated by feeding the lookup table with the upper four bits of previous-frame data (start gradations) and the upper four bits of input data (target gradations), both the start and target gradations take discrete values, like 0, 16, 32, and so forth. This produces cliffs in output data, i.e., in overdrive gradations. Specifically, throughout the range of input data (target gradations) from “xxxx0000” to “xxxx1111” (in decimal notation, from 0 to 15, from 16 to 31, and so forth), output data has the same gradation value. By contrast, with the driving method described above, when input data is “xxxx0001”, the output “yyyy” of the lookup table is combined with “0001” to generate “yyyy0001”; when input data is “xxxx0011”, the output “yyyy” of the lookup table is combined with “0011” to generate “yyyy0011”. Thus, the method helps avoid output data having the same gradation value.

However, as will be understood from FIG. 2, the method does help reduce the number of cliffs, but does not go so far as to eliminate them. For example, when previous-frame data has zero gradations and the target gradation is “16”, the demanded gradation is “32”; by contrast, when previous-frame data has zero gradations and the target gradation is “15”, the demanded gradation is “15”. Thus, there remains a cliff between the target gradations “15” and “16”. Disadvantageously, the presence of such cliffs (in particular where the slope is steep) causes afterimages to be observed rather clearly when scrolling is performed on a liquid crystal screen.

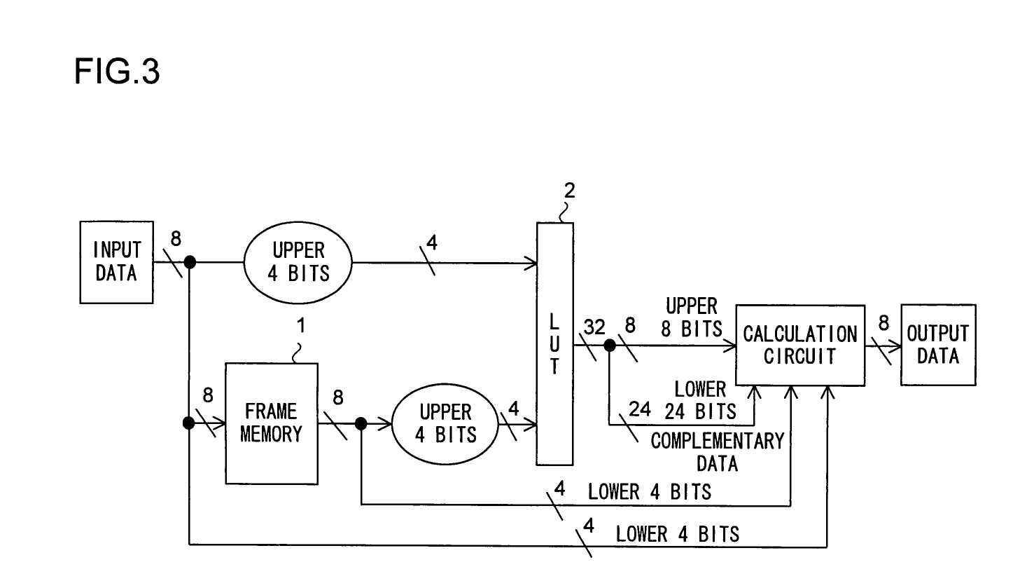

Now, a configuration improved in this respect will be described. In a liquid crystal panel drive device configured as shown in FIG. 3, eight-bit previous-frame data is read out from a frame memory. Input data (target data) also is eight-bit data. The upper four bits of the previous-frame data and the upper four bits of the input data are fed, as an address, to a lookup table (LUT). This lookup table has, at each address, 32-bit data, of which the lower 24 bits form complementary data. This complementary data corresponds to the aforementioned cliffs (or slopes).

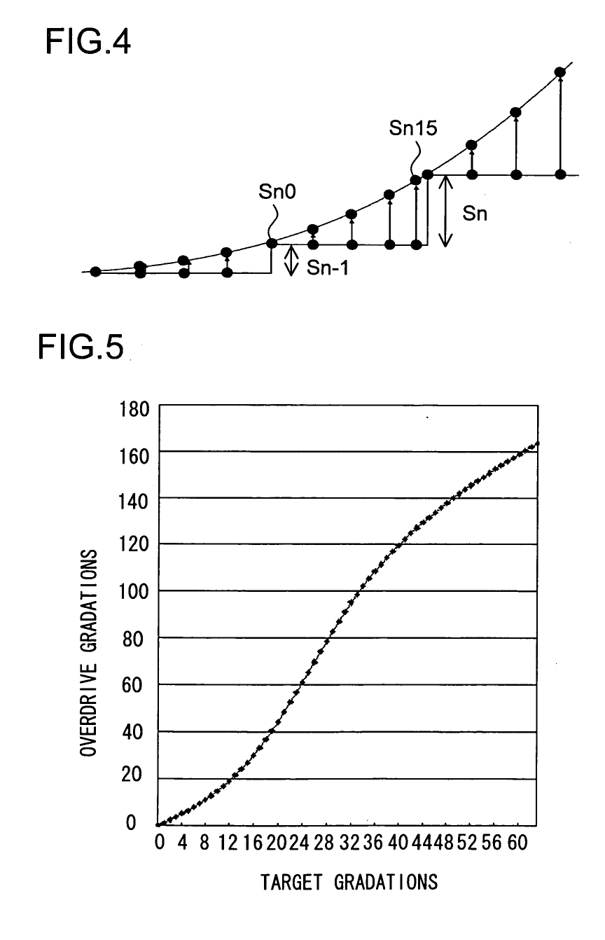

The lower four bits of the previous-frame data, the lower four bits of the input data, and the lower 24 bits (complementary data) of the lookup table are fed to a calculation circuit, which then generates correction data for the upper eight bits of the lookup table. As shown in FIG. 4, the calculation performed here is equivalent to lifting up (giving a slope to) overdrive gradations in such a way as to round out cliffs S so that overdrive gradations better correlate with target gradations. Specifically, at a given cliff Sn, throughout the range of input data from “xxxx0000” to “xxxx1111”, the upper four bits from the lookup table remain the same (indicating the gradation indicated by Sn0). Here, calculation is performed such that, when the input data is “xxxx1111”, the gradation is lifted up from the position Sn0 to the highest position Sn15 within the cliff Sn and, when the input data is “xxxx0000”, the gradation is kept at the position Sn0 without any lifting-up therefrom. Likewise, any gradation in between is lifted up according to where it is located.

In the calculation circuit, the correction data generated based on the lower 24 bits (complementary data) of the lookup table etc. is added to the data of the upper eight bits of the lookup table, and in this way eight-bit output data is generated. The calculation circuit that performs the calculation described above can be built with various configurations, among which are preferred those which yield, as shown in FIG. 5, overdrive gradations without cliffs (when previous-frame data has zero gradations).

Next, a description will be given of a configuration that permits, of different lookup tables, an appropriate one to be selected according to temperature. In the following description, for the sake of simplicity, no mention will be made of the configuration in which the output from a lookup table is corrected based on complementary data by a calculation circuit. It should be understood, however, that it is preferable to use, even in the embodiment that is going to be described below, the configuration in which the output from a lookup table is corrected based on complementary data.

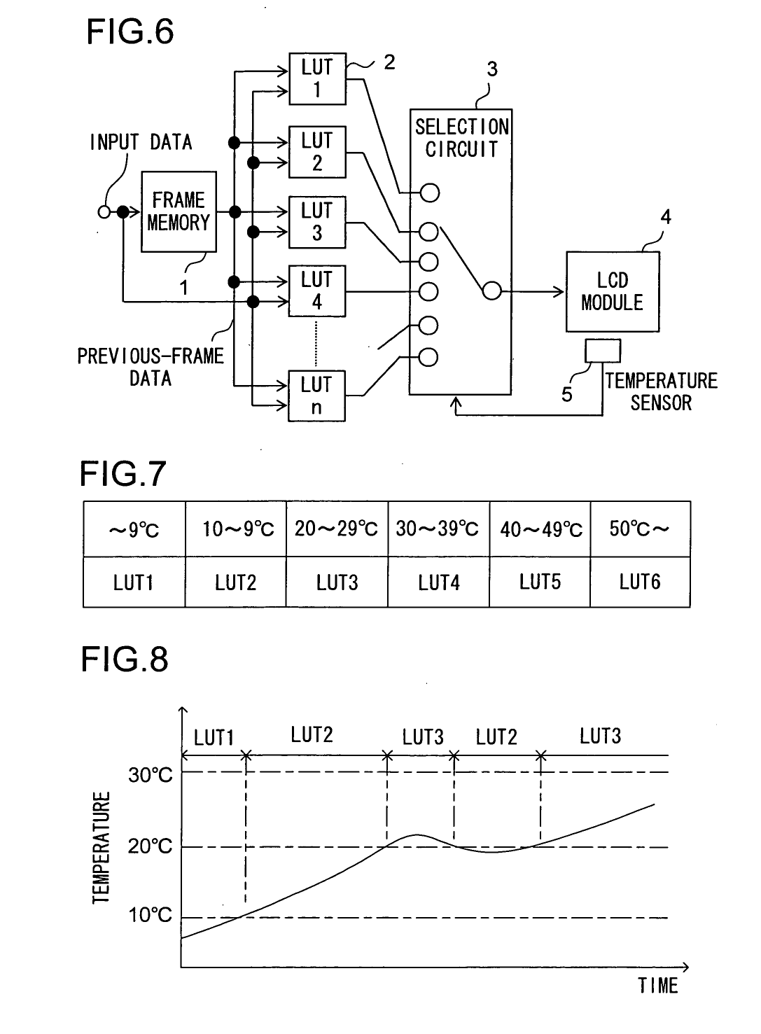

In a liquid crystal panel drive device configured as shown in FIG. 6, eight-bit input data (target data) is fed to and held in a frame memory 1 that can store data corresponding to one frame. This input data is to be used to achieve gradation display, and is fed out, one frame period later, as start data. That is, when input data is newly fed to the frame memory 1, the data one frame previous to it (hereinafter referred to as previous-frame data) is read out, as start data, from the frame memory 1. Then, for example, the upper four bits of the previous-frame data and the upper four bits of the input data are fed, as an address, to lookup tables 2 (LUT1 to LUTn).

In the lookup tables 2, data for overdriving is stored beforehand that has been so set as to correspond to previous-frame data and input data. Since the overdrive voltage varies with the ambient temperature, here, a plurality of lookup tables are prepared that store data corresponding to different temperatures respectively. These lookup tables are switched from one to another by a selection circuit 3, and the data of the selected lookup table is fed to a liquid crystal (LCD) module 4.

Based on temperature information fed from a temperature sensor 5 or the like, the selection circuit 3 selects, from among the lookup tables LUT1 to LUTn, the most appropriate one. As shown in FIG. 7, the lookup table LUT1 stores data corresponding to the temperature range of 9° C. and lower, the lookup table LUT2 stores data corresponding to the temperature range from 10° C. to 19° C., the lookup table LUT3 stores data corresponding to the temperature range from 20° C. to 29° C., and so forth. In this way, for every 10√ C. temperature range, the optimum overdrive data for that temperature range is stored in the lookup tables 2. In this example, from among the lookup tables LUT1 to LUTn, only the one that is most appropriate is selected. FIG. 6 shows the state in which the LUT2 is being selected.

The liquid crystal module 4 is built with a liquid crystal panel, a drive circuit for driving it, and a frame in which they are housed. The liquid crystal module 4 is fitted with a temperature sensor 5 for detecting the temperature of the liquid crystal panel itself or the ambient temperature around it. The temperature information detected by the temperature sensor 5 is fed to the selection circuit 3, which then uses it to select among the lookup tables.

In this configuration, as shown in FIG. 8, as the temperature detected by the temperature sensor 5 varies with time, the lookup tables are switched from one to another, as from LUT1 to LUT2, then to LUT3, and so forth, so that one of them is selected at a time and the overdrive data stored in that lookup table is selectively fed to the liquid crystal module 4.

In a case where the lookup tables are so set as to correspond to different temperature ranges as shown in FIG. 7, if temperature fluctuates, for example, around 20° C., the lookup tables LUT2 and LUT3 are switched between each other frequently. To prevent such frequent switching among lookup tables, it is preferable that hysteresis be introduced in the switching of the lookup tables according to temperature.

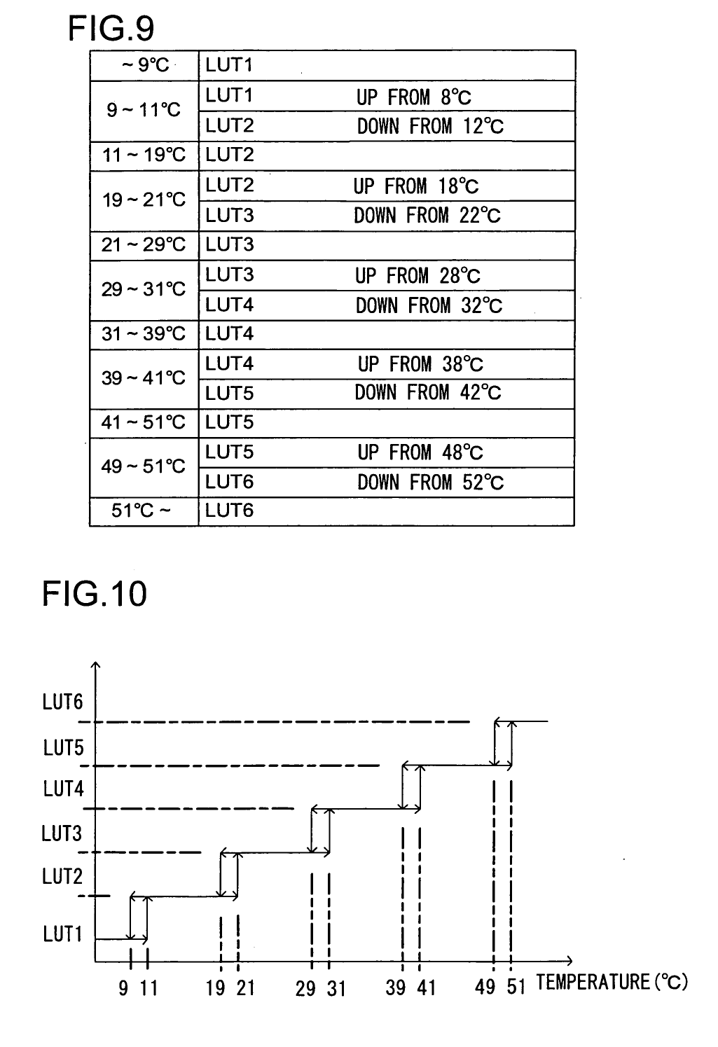

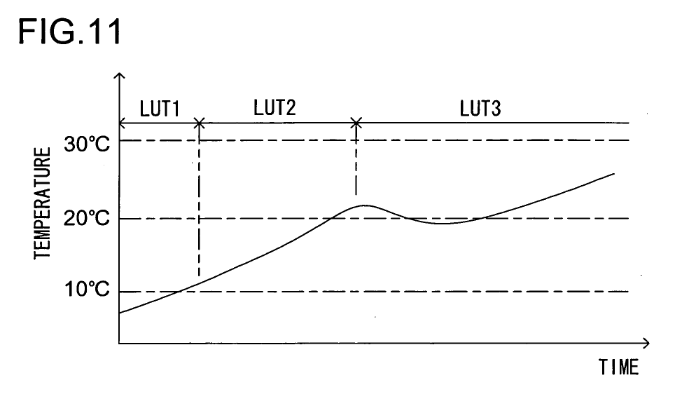

FIG. 9 is a diagram illustrating an example of the correspondence between temperatures and the lookup tables selected at those temperatures when hysteresis is introduced. As shown in FIG. 9, around each border across which the switching of lookup tables takes place, a region (overlap region) is secured in which different lookup tables are selected depending on whether temperature is rising or falling. Specifically, these overlap regions are so set that, when temperature rises or falls into an overlap region, the lookup table that has thus far been selected is retained. FIG. 10 is a diagram in which what is shown in FIG. 9 is plotted in the form of a graph, with the horizontal axis representing temperature and the vertical axis representing the selected lookup table. Advisably, such hysteresis is set beforehand within the selection circuit 3. With hysteresis secured in this way, when the temperature detected by the temperature sensor 5 varies as shown in FIG. 8, the lookup tables LUT1 to LUT3 are selected as shown in FIG. 11. Thus, the lookup tables are switched less frequently than in the case shown in FIG. 8.

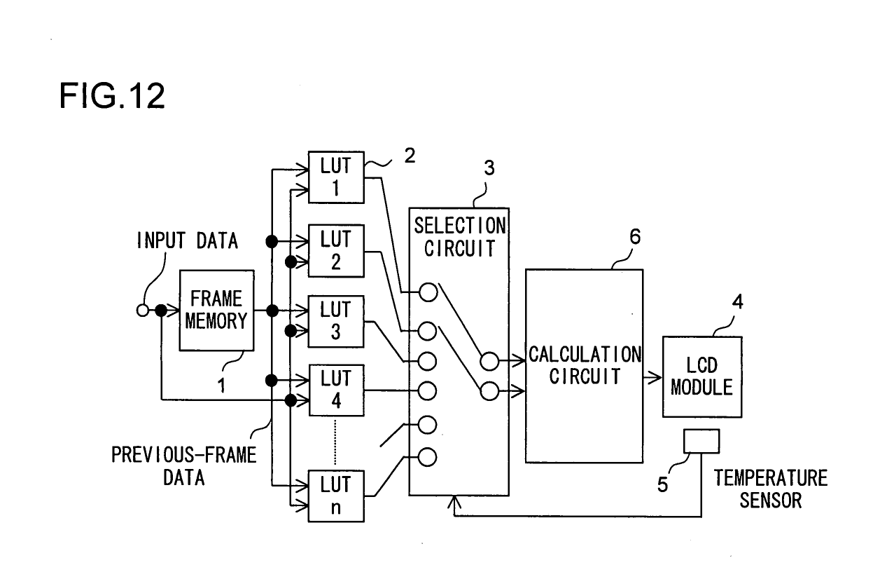

The embodiment described above deals with an example in which, from among a plurality of lookup tables so set as to correspond to different temperature ranges, only one is selected according to temperature. Alternatively, as shown in FIG. 12, two lookup tables may be selected simultaneously. Specifically, based on the temperature information detected by a temperature sensor 5, a selection circuit 3 selects two lookup tables, and the output data from these lookup tables is fed to a calculation circuit 6. Here, the selection circuit 3 is so built as to select two lookup tables corresponding to two consecutive temperature ranges. Alternatively, the selection circuit 3 may be so built as to select two or more lookup tables in any other relationship with one another.

Based on the data fed from the two lookup tables selected by the selection circuit 3, the calculation circuit 6 calculates and outputs overdrive data (the amount of overdrive) interpolated between the data of those two lookup tables. This interpolated overdrive data is then fed to a liquid crystal module 4. In this way, in this configuration, data corresponding to temperatures between the temperature ranges covered by two lookup tables is calculated by interpolation. This makes it possible to generate interpolated data from a small number of lookup tables, and thus helps reduce the number of lookup tables needed.

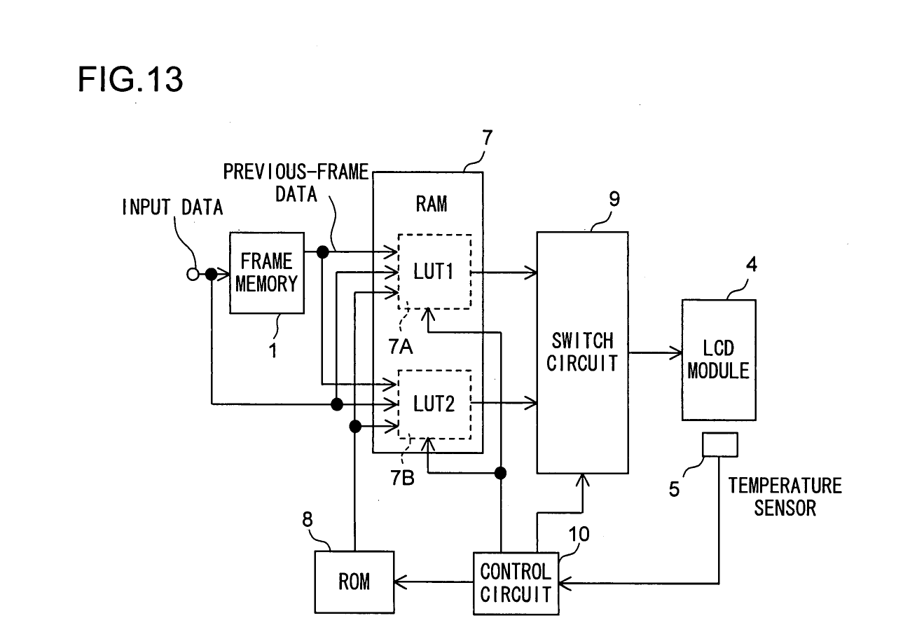

In the embodiment described above, the frame memory 1 and the lookup tables 2 are realized with storage devices (memory) with high-speed response. An example of high-speed response memory is RAM. However, since high-speed response memory is expensive, it is often impractical to use as much of it as desired. Thus, to reduce the use of high-speed response memory, in the embodiment shown in FIG. 13, high-speed response memory 7 and low-speed response memory 8 are used in combination for the storage of lookup tables. In FIG. 13, the low-speed response memory 8 is realized with ROM.

A plurality of lookup tables (corresponding to LUT2 to LUTn in FIG. 12) so set as to correspond to different temperature ranges are all stored in the low-speed response memory 8. Whenever used, the lookup tables stored in the low-speed response memory 8 is read out therefrom and stored in the high-speed response memory 7 under the control of a control circuit 10.

In the example under discussion, the high-speed response memory 7, in which lookup tables are stored temporarily, is built with a memory device with a capacity large enough to store a plurality of, in this example two, lookup tables. Alternatively, the high-speed response memory 7 may be built with a memory device with a capacity large enough to store one lookup table. Based on the temperature information detected by a temperature sensor 5, the control circuit 10 reads out lookup tables from the low-speed response memory 8, and writes them to a first and a second memory region 7A and 7B in the high-speed response memory 7. The lookup tables written to the first and second memory regions 7A and 7B correspond to different temperature ranges, and the data read out from one of the first and second memory regions 7A and 7B is fed via a switch circuit 9 to a liquid crystal module 4. Based on the temperature information fed from the temperature sensor 5, the control circuit 10 selects which lookup table to read out from the low-speed response memory 8 and store in the high-speed response memory 7.

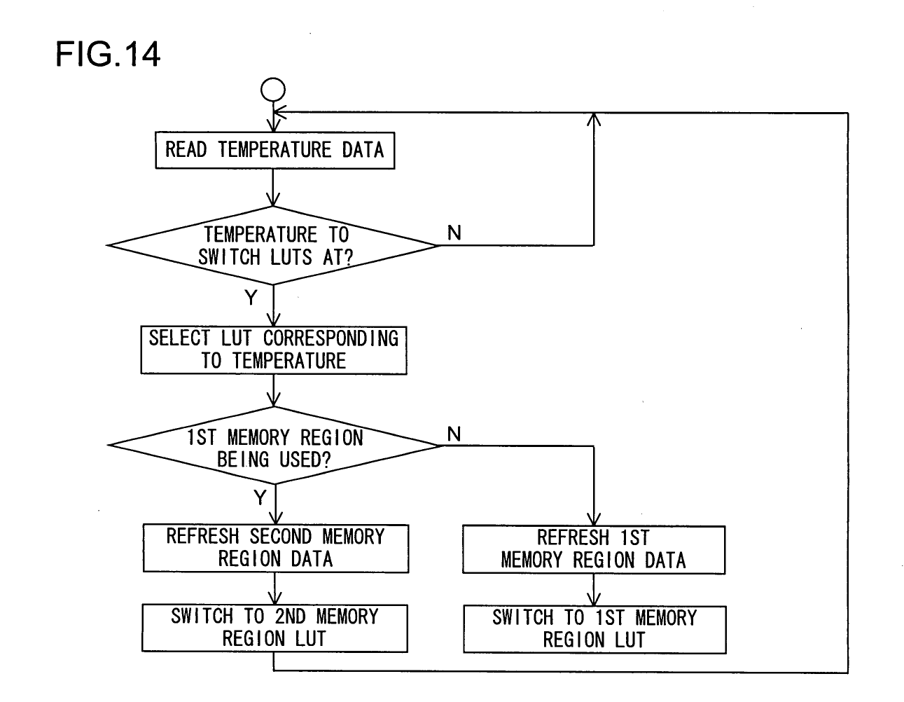

FIG. 14 is a flow chart showing an example of the operation of the embodiment of which the block diagram is shown in FIG. 13. As shown in this flow chart, based on the information from the temperature sensor 5, when temperature is found to be that at which to switch lookup tables, of the lookup tables stored in the low-speed response memory 8, the one corresponding to the temperature is selected. If one of the regions (the first memory region 7A) in the high-speed response memory is currently being used, the lookup table read out is stored in the other region (the second memory region 7B) in the high-speed response memory, and the switch circuit 9 so operates that the lookup table stored in this second memory region 7B is selected so as to be fed to the liquid crystal module 4. If one of the regions (the first memory region 7A) in the high-speed response memory is not currently being used, the lookup table read out is stored in this region (the first memory region 7A) in the high-speed response memory, and the switch circuit 9 so operates that the lookup table stored in this second memory region 7B is selected so as to be fed to the liquid crystal module 4. In this way, when data is read out from the low-speed response memory 8, the two memory regions in the high-speed response memory 7 are used alternately. This helps minimize the influence of low-speed operation of the low-speed response memory 8.

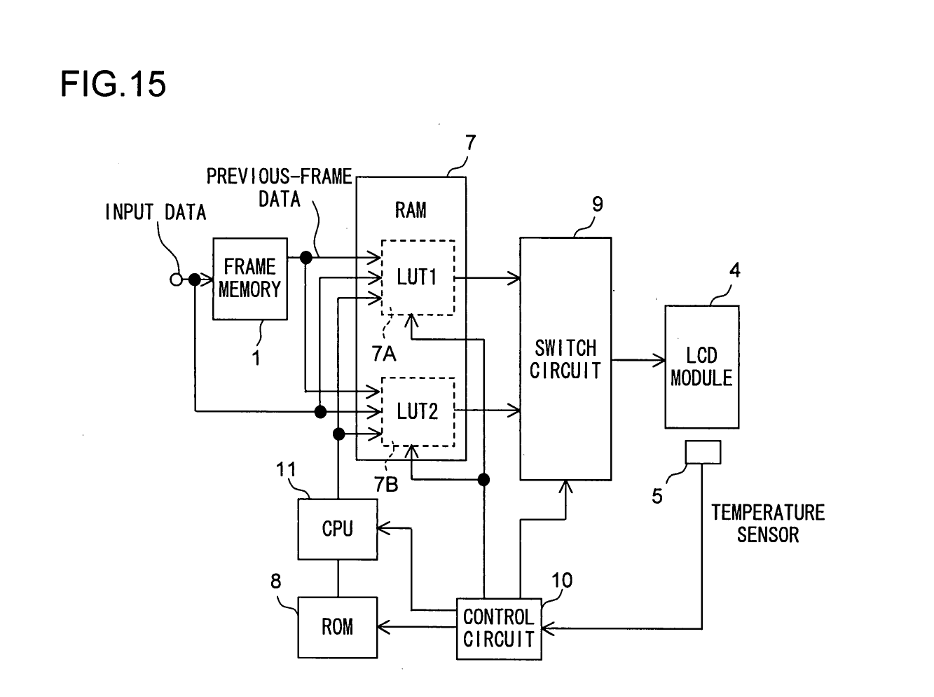

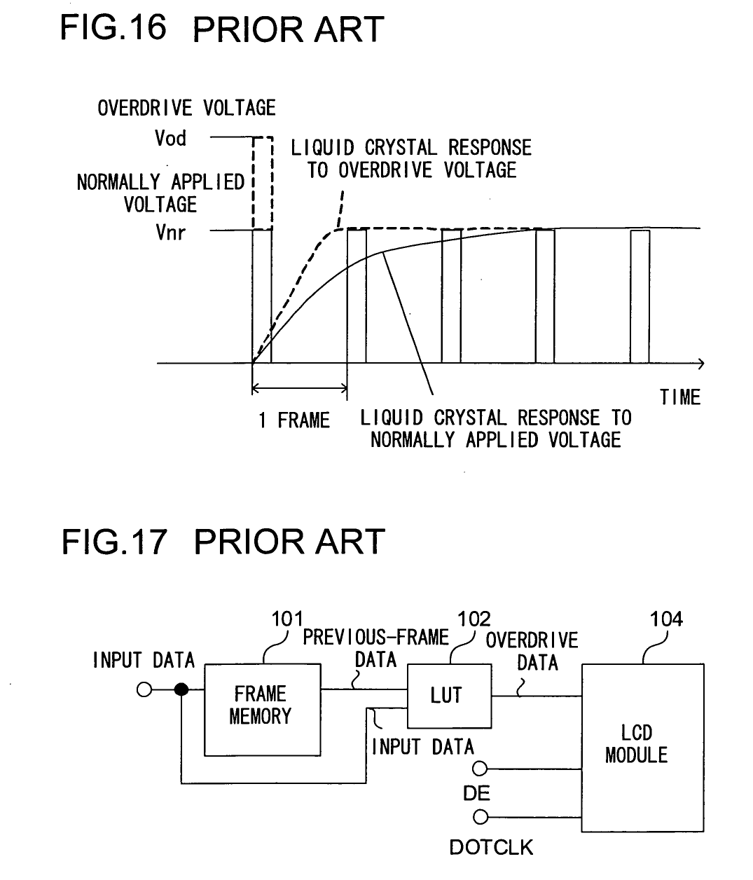

FIG. 15 shows an embodiment that is a slightly modified version of the embodiment shown in FIG. 13. The modification lies in that a circuit 11 is additionally provided for performing data processing, such as data interpolation, when lookup table data is read out from low-speed response memory 8 and stored in high-speed response memory 7. It is preferable that this data processing be accomplished by exploiting arithmetic functions of a CPU or the like, because performing it with a dedicated circuit will require a complicated circuit design.

### INDUSTRIAL APPLICABILITY

As discussed above, with a liquid crystal panel drive device according to the present invention, it is possible to achieve overdriving even in the face of variations in the ambient temperature, contributing to higher display quality on a liquid crystal panel. Moreover, it is possible to realize a driving method and a driving apparatus that require a smaller number of expensive storage devices.

1. A liquid crystal panel drive device that achieves overdriving by using a frame memory and a lookup table, wherein a plurality of lookup tables are provided so as to correspond to different temperatures, and the lookup tables are switched from one to another so that one of the lookup tables is selectively used according to information indicating an ambient temperature, and wherein the lookup tables are switched from one to another with hysteresis secured in between.

2. (canceled)

3. The liquid crystal panel drive device of claim 1, wherein, based on a first lookup table corresponding to a first temperature and a second lookup table corresponding to a second temperature immediately above or below the first temperature, an interpolated amount of overdrive corresponding to a temperature between the first and second temperatures is calculated.

4. The liquid crystal panel drive device of claim 1, wherein a first storage device in which the plurality of lookup tables are stored and a second storage device, having a smaller storage capacity than the first storage device, for storing a lookup table read out from the first storage device are provided, and a predetermined number, corresponding to the ambient temperature, of lookup tables are read out from the first storage device and stored in the second lookup table.

5. The liquid crystal panel drive device of claim 4, wherein, when lookup tables are read out from the first storage device and stored in the second storage device, corrections are made according to temperature information.

6. A liquid crystal panel drive device that achieves overdriving by using a frame memory and a lookup table, wherein a plurality of lookup tables are provided so as to correspond to different temperatures, and the lookup tables are switched from one to another so that one of the lookup tables is selectively used according to information indicating an ambient temperature, and wherein the lookup table is fed with part of previous-frame data read out from the frame memory and part of input data, and data for overdriving is generated based on another part of the input data which is not fed to the lookup table and output data from the lookup table.

7. A liquid crystal panel drive device that achieves overdriving by using a frame memory and a lookup table, wherein a plurality of lookup tables are provided so as to correspond to different temperatures, and the lookup tables are switched from one to another so that one of the lookup tables is selectively used according to information indicating an ambient temperature, and wherein the lookup table is fed with part of previous-frame data read out from the frame memory and part of input data, output data from the lookup table is so set that part thereof is used as complementary data, correction data is generated based on another part of the input data which is not fed to the lookup table and the part of the output data from the lookup table which is used as the complementary data, and data for overdriving is generated based on the correction data and non-complementary part data from the lookup table.
